(19) United States
(12) Patent Application Publication
(10) Pub. No.: US 2016/0239409 A1
(43) Pub. Date: Aug. 18, 2016

(54) TESTING A WEB SERVICE USING INHERITED TEST ATTRIBUTES

(71) Applicant: HEWLETT PACKARD ENTERPRISE DEVELOPMENT LP, Houston, TX (US)

(72) Inventors: Ricardo Alexandre de Oliveira Staudt, Porto Alegre (BR); Hugo Vares Vieira, Porto Alegre (BR); Karine de Pinho Peralta, Porto Alegre (FR); Mairo Pedrini, Porto Alegre (BR)

(21) Appl. No.: 15/028,509

(22) PCT Filed: Oct. 17, 2013
(86) PCT No.: PCT/US2013/065494

§ 371 Date: Apr. 11, 2016

(30) Foreign Application Priority Data
Feb. 18, 2014 (TR) 2014/01913

(51) Int. Cl. G06F 11/36

(52) U.S. Cl. CPC G06F 11/3688; G06F 11/3684

(57) ABSTRACT

A method for testing a web service using inherited test attributes is described. The method includes generating a test template for a web service entry point, in which a test template comprises a number of test attributes, generating a number of test elements based on the test template, in which a test element inherits the number of test attributes, and executing the number of test elements.

### BACKGROUND

Many organizations use web services to share information over a network. For example, businesses and clients may connect with one another, and share information and perform operations and transactions via web services. As these web services expand to provide new features and adapt to business organizations, the web services may be tested to ensure adequacy and functionality. Accordingly, tests may be performed to determine whether a web service functions as expected.

### BRIEF DESCRIPTION OF THE DRAWINGS

The accompanying drawings illustrate various examples of the principles described herein and are a part of the specification. The illustrated examples do not limit the scope of the claims.

FIG. 1 is a diagram of a system for testing a web service using inherited test attributes according to one example of the principles described herein.

FIG. 2 is a flowchart of a method for testing a web service using inherited test attributes according to one example of the principles described herein.

FIG. 3 is a diagram of the hierarchy of a testing system according to one example of the principles described herein.

FIG. 4 is a flowchart of another method for testing a web service using inherited test attributes according to another example of the principles described herein.

FIG. 5 is a diagram of a system for testing a web service using inherited test attributes according to one example of the principles described herein.

FIG. 6 is a test report according to one example of the principles described herein.

Throughout the drawings, identical reference numbers designate similar, but not necessarily identical, elements.

### DETAILED DESCRIPTION

Web services may allow businesses and clients to connect to one another and to share information over a network. Web services may also facilitate networking. For example via a web service a user may engage in social networking activities and transactions and operations with other users among other networking activities. In either case, web services may be a valuable asset to an organization or other users. Maintaining quality web services may be a challenging task. For example, fast and safe expansion of a web service may be desired when connecting new businesses. An expansion of a web service may also necessitate additional operating parameters that may lead to changes in a web service. Additionally, backward compatibility with previous versions of a web service is also desirable to support existing connections. To meet both these needs, web services may implement regression tests and functional tests. Regression testing may play a role in assuring that the quality of the web service is maintained throughout its life cycle. For example, bugs, viruses, programming errors, or other elements may inhibit a properly functioning web service. Via a regression test, these elements may be identified, processed, and remedied. Regression tests may also be used to determine if a change to a particular feature of a web service affects other features of a web service. By comparison, a functional test may be used to determine if an operation enabled by a web service functions as expected. While regression testing and functional testing may facilitate an improved, secure, and stable functionality of a web service, there are many complications that make implementation of regression testing difficult.

For example, the cost and effort to maintain a large suite of regression tests that offer an adequate level of coverage may be prohibitively high. Accordingly, available regression and functional test suites may have reduced coverage, delayed releases, or combinations thereof. One of the biggest challenges with current methods is to provide regression and functional tests that support growth of a web service. Additionally, large suites of regression and functional tests may include redundancies which are inefficient and difficult to update. For example, according to current methods, tests are self-contained carrying all the attributes associated with the test. Accordingly, any update to a test suite may include updating each individual test in a suite.

Accordingly, the present disclosure describes systems and methods for testing web services using inherited test attributes. More specifically, the present disclosure describes a system for testing a web service that enables test information to be reused, rather than rewritten. The system implements a hierarchical structure that enables the reuse of test attributes. Doing so may simplify the generation of new tests as existing test attributes may be inherited from a source, rather than generated with each instance of a test element. Simplifying the generation of new tests in this fashion allows a test suite to grow while remaining maintainable.

Using the systems and methods described herein, test templates which include a number of test attributes may be generated. Test elements, which are executable operations to test a functionality of a web service, may inherit the test attributes and may be customized by modifying the test attribute within the test element, leaving the test attribute in the test template unmodified. Similarly, when a test template is updated based on a change to the web service, the test attributes in the test elements that are affected by the change may be updated via the inheritance between the test template and test element. As will be described below, test attributes may be inherited by the test elements at runtime execution of the test elements. Accordingly, any updates made to the test template before a test element is executed, may be inherited by the test element during runtime execution.

The present specification describes a method for testing a web service using inherited test attributes. The method may include generating a test template for a web service entry point. A test template may include a number of test attributes. The method may also include generating a number of test elements based on the test template. A test element may inherit the number of test attributes. The method may include executing the number of test elements.

The present specification describes a system for testing a web service using inherited test attributes. The system may include a processor and a memory communicatively coupled to the processor. The memory may include a context module to store a number of test templates for a number of web service entry points. A test template may include a number of test attributes to describe a web service entry point. The memory may also include a parser to generate a number of test elements to test the web service. The number of test elements may inherit the number of test attributes from the number of test templates. The memory may also include a runner to execute the number of test elements.

The present specification describes a computer program product for testing a web service using inherited test attributes. The computer program product may include a computer readable storage medium that may include computer usable program code embodied therewith. The computer usable program code may include computer usable program code to, when executed by a processor, generate a test template for a web service entry point. The test template comprises a number of test attributes. The computer usable program code may include computer usable program code to, when executed by a processor, generate a number of test elements based on the test template. The test element inherits the number of test attributes. The computer usable program code may include computer usable program code to, when executed by a processor, group a number of test elements into a number of test cases. The computer usable program code may include computer usable program code to, when executed by a processor, execute the number of test cases. The computer usable program code may include computer usable program code to, when executed by a processor, generate a test report based on the execution of the test cases.

The systems and methods described herein may be beneficial by limiting redundancy in a test suite, reducing the time and cost to maintain complex test suites, and potentially improving the speed in which users can connect with one another via a web service.

As used in the present specification and in the appended claims, the term “web service” may include any method of communication between two electronic devices over a network.

Further, as used in the present specification and in the appended claims, the term “entry point” or “web service entry point” may refer to a method of accessing a web service. For example, a web page, or a tab in a web page may be an entry point to a web service. In another example, an ability to post information to a web site may be one entry point, and an ability to search a web site may be another entry point.

Yet further, as used in the present specification and in the appended claims, the term “test,” “testing,” or similar terminology may refer to functional testing, regression testing, or combinations thereof. Functional testing and regression testing may be similar test procedures targeting different states of a web service. For example, a web service may enable an operation. A functional test may indicate whether the operation executes as expected. By comparison, a regression test may indicate whether a change to a particular feature of a web service affects other features of the web service, throughout the service life cycle.

Still further, as used in the present specification and in the appended claims, the term “a number of” or similar language may include any positive number including 1 to infinity; zero not being a number, but the absence of a number.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

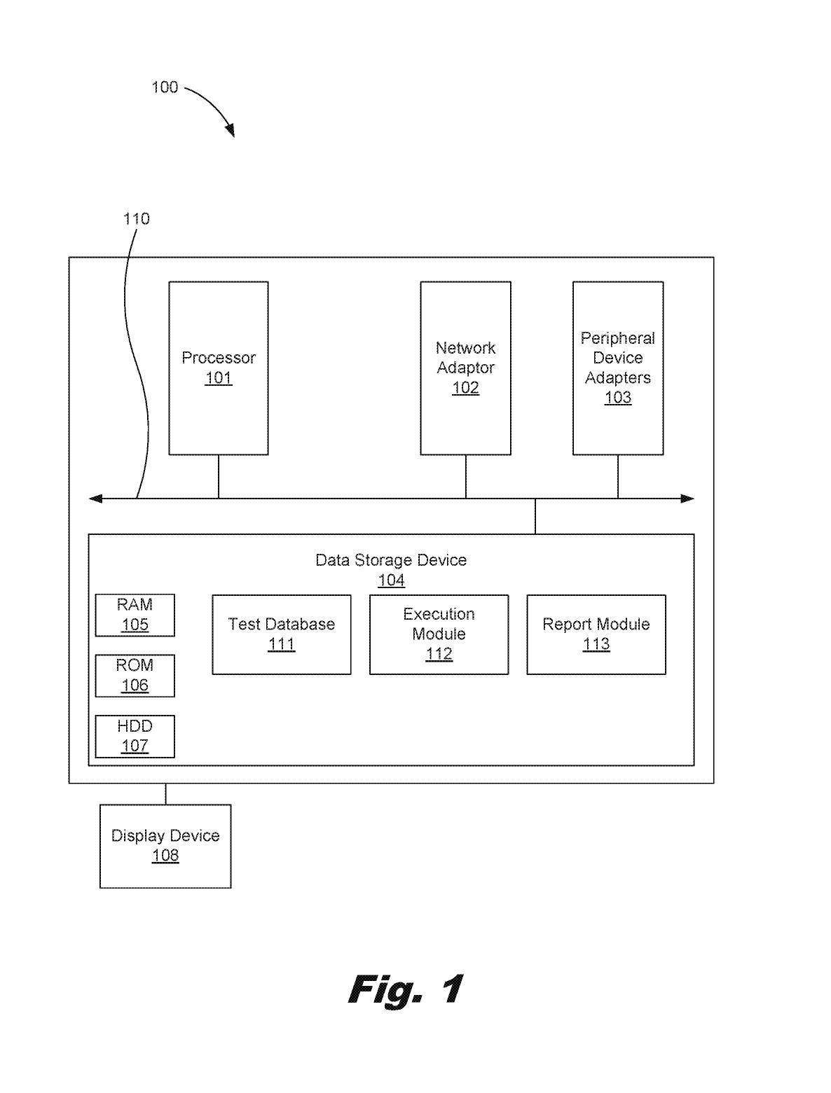

Turning now to the figures, FIG. 1 is a diagram of a system (100) for testing a web service using inherited test attributes, according to one example of the principles described herein. The system (100) may be utilized in any data processing scenario including, for example, a cloud computing service such as a Software as a Service (SaaS), a Platform as a Service (PaaS), a Infrastructure as a Service (IaaS), application program interface (API) as a service (APIaaS), other forms of network services, or combinations thereof. Further, the system (100) may be used in a public cloud network, a private cloud network, a hybrid cloud network, other forms of networks, or combinations thereof, In one example, the methods provided by the system (100) are provided as a service over a network by, for example, a third party. In another example, the methods provided by the system (100) are executed by a local administrator.

Further, the system (100) may be utilized within a single computing device. In this data processing scenario, a single computing device may utilize the associated methods described herein to test web services using inherited test attributes.

To achieve its desired functionality, the system (100) comprises various hardware components. Among these hardware components may be a number of processors (101), a number of data storage devices (104), a number of peripheral device adapters (103), and a number of network adapters (102). These hardware components may be interconnected through the use of a number of busses and/or network connections. In one example, the processor (101), data storage device (104), peripheral device adapters (103), and a network adapter (102) may be communicatively coupled via bus (110).

The processor (101) may include the hardware architecture to retrieve executable code from the data storage device (104) and execute the executable code. The executable code may, when executed by the processor (101), cause the processor (101) to implement at least the functionality of web service testing using inherited test attributes, according to the methods of the present specification described herein. In the course of executing code, the processor (101) may receive input from and provide output to a number of the remaining hardware units.

The data storage device (104) may store data such as executable program code that is executed by the processor (101) or other processing device. As will be discussed, the data storage device (104) may specifically store a number of applications that the processor (101) executes to implement at least the functionality described herein.

The data storage device (104) may include various types of memory modules, including volatile and nonvolatile memory, For example, the data storage device (104) of the present example includes Random Access Memory (RAM) (105), Read Only Memory (ROM) (106), and Hard Disk Drive (HDD) memory (107). Many other types of memory may also be utilized, and the present specification contemplates the use of many varying type(s) of memory in the data storage device (104) as may suit a particular application of the principles described herein. In certain examples, different types of memory in the data storage device (104) may be used for different data storage needs. For example, in certain examples the processor (101) may boot from Read Only Memory (ROM) (106), maintain nonvolatile storage in the Hard Disk Drive (HDD) memory (107), and execute program code stored in Random Access Memory (RAM) (105).

Generally, the data storage device (104) may comprise a computer readable medium, a computer readable storage medium, or a non-transitory computer readable medium, among others. For example, the data storage device (104) may be, but not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. In another example, a computer readable storage medium may be any non-transitory medium that can contain, or store a program for use by or in connection with an instruction execution system, apparatus, or device.

The hardware adapters (103) in the system (100) enable the processor (101) to interface with various other hardware elements, external and internal to the system (100). For example, peripheral device adapters (103) may provide an interface to input/output devices, such as, for example, display device (108). The display device (108) may be provided to allow a user to interact with and implement the functionality of the system (100). For example, via the display device (108) a report may be generated that indicates the results of a test element or test case. The peripheral device adapters (103) may also create an interface between the processor (101) and a printer, the display device (108), or other media output device. The network adapter (102) may provide an interface to other computing devices within, for example, a network, thereby enabling the transmission of data between the system (100) and other devices located within the network.

The system (100) further comprises a number of modules used in testing a web service. The various modules within the system (100) may be executed separately. In this example, the various modules may be stored as separate computer program products. In another example, the various modules within the system (100) may be combined within a number of computer program products; each computer program product comprising a number of the modules.

The system (100) may include a test database (111) to store a number of test templates for a web service entry point. As described above, a web service may refer to a way to communicate data between electronic devices on a network. An example of a web service may be a social networking service. Accordingly, a web service entry point may refer to a way to access a particular web service. For example, the social networking web service may allow users to post information to the social network. Posting information to the social networking web service may be one example of a web service entry point. In some examples, the web service may have multiple entry points. For example, the social networking web service may allow users to search the web service for certain information. The ability to search the social networking web service may be another example of a web service entry point. Accordingly, the social networking web service may have multiple entry points in the post entry point and the search entry point. Another example of a web service and various entry points is given as follows. A particular web page may be a web service entry point. Different tabs on the web site may be examples of various web service entry points for the web page service. While specific reference is made to social networking web service and a web page, the principles described herein may be used with any number of web services including web services that facilitate transactions between different entities.

The test templates stored in the test database (111) may describe the web service entry point to be tested. As the test templates include information that describes the web service entry point, the test template may be used to generate documentation that describes the web service entry point.

More specifically, the test templates may include a number of test attributes. The test attributes may describe the web service entry point. One example of a test attribute is a path attribute which indicates a unique location within a web service where an entry point may be located. In other words, the path attribute may be a location where specific data in a web service may be retrieved from, or submitted to. Another example of a test attribute that may be included in a test template is a method attribute to indicate a desired action to be performed at the identified entry point. For example, a “GET” method attribute may indicate that data is to be retrieved from the entry point. In another example, a “POST” method attribute may indicate that data is to be submitted and processed at an entry point. Yet another example of an attribute is a body attribute that contains a message to be displayed. While specific reference is made to path attributes, and method attributes, an attribute may include any element that is used in a test template to describe a web service entry point.

Using the test attributes from the test template contained in the test database (111), the execution module (112) may generate a test element that inherits the test attributes from the test template. Storing the test templates in the test database (111) as described may be beneficial in that it represents a single location where information that may be used multiple times may be stored. Accordingly, when variations of the test template are used, the test template may be a starting point and alleviate any redundancy in creating test attributes that have already been created. Moreover any updates to the test template may be inherited by the test elements generated by the execution module (112) during runtime execution of the test elements. As will be described below, the test database (111) may also include other information such as configuration information and a number of test suites.

The data storage device (104) may also include an execution module (112) to execute the test elements. More specifically, the execution module (112) may generate a number of test elements to test the web service entry point. For example, a test element may test whether a web service entry point performs an operation of activation. In another example, the test element may test whether a web service entry point retrieves information from the web service.

The execution module (112) may generate test elements that inherit a number of test attributes from the number of test templates. For example, a test element may inherit a path attribute and a method attribute from the test template. As will be described below, the execution module (112) may also overwrite a number of test attributes that are inherited. The execution module (112) may generate the number of test elements, and inherit the number of test attributes during run-time. For example, upon instruction to carry out a test, the execution module (112) may generate a test element, and allow the number of test attributes to be inherited by the test element. Prior to the execution of a test element, a link between test attributes in the test template and test attributes in the test element may be “soft.”

The execution module (112) may execute the number of test elements. For example, the execution module (112) may request information from the web service. Accordingly, the execution module (112) may receive a response to the request and validate the response. Validation of a response may include comparing the response against an expected result. In some examples, the expected response may be referred to as an assertion.

The data storage device (104) may include a report module (113) that generates a report based on the execution of the test elements. More specifically, the report module (113) may indicate whether a response to a request has been validated. In other words, the report module (113) may generate a report that indicates whether a response is the response expected for proper functioning of the web service entry point. A validated response may “pass” the test and a response that is not validated may “fail” the test.

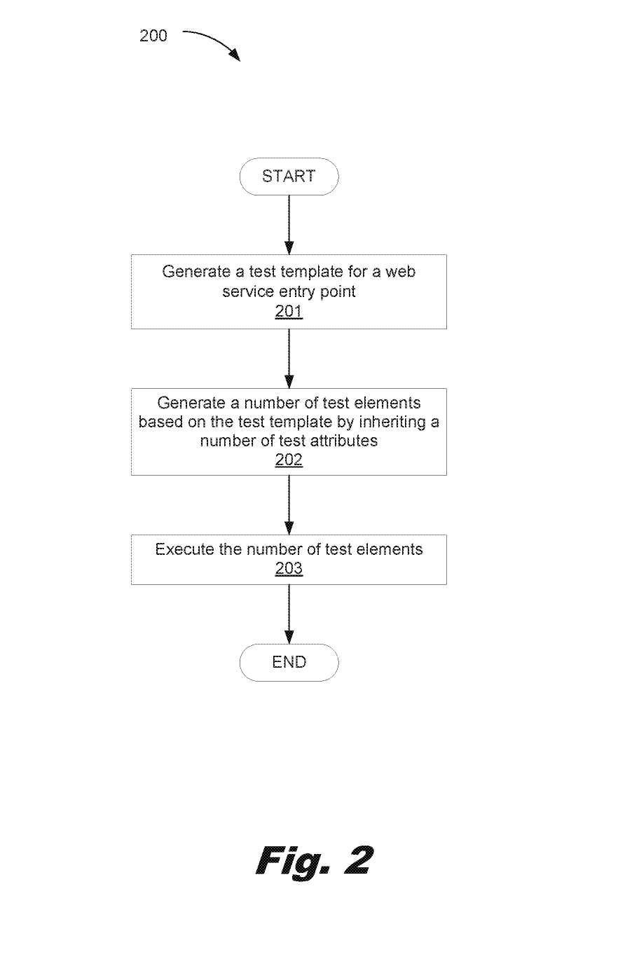

FIG. 2 is a flowchart of a method (200) for testing a web service using inherited test attributes, according to one example of the principles described herein. The method (200) may begin by generating (block 201) a test template for a web service entry point. As described above, a test template may describe, using test attributes, a web service entry point. Such attributes may include a path attribute, a method attribute, a body attribute, and assertions. Including the test attributes in the test template may be beneficial in that the test attributes may be stored in a single location, rather than in each test element that implements the test attribute.

A particular type of test attribute that may be included in a test template is an assertion. An assertion may be an expected result from a response to a request. An example of an assertion is given as follows. A test element may request a web service entry point to return a particular type of information. In response, the web service entry point may return the information. The returned information, or response, may be compared against the assertion to indicate whether the response is what is expected by the test element. If the response is what was expected, the test element may be validated. By comparison, if the response is not what was expected, the test element may not be validated. Validation, or returning an expected response, may indicate that the web service entry point is functioning properly.

A number of test elements may be generated (block 202) based on the test template. As described above, a test element may test a functionality of a web service entry point. The test element may carry out functional testing, regression testing, or combinations thereof. For example, a test element may test whether a web service entry point carries out a particular operation. Other examples of test elements include testing whether a web service entry point receives input information and whether a web service entry point sends output information, among other functionalities.

In generating (block 202) a number of test elements, the test elements may inherit a number of test attributes from the test template. For example, when a test element is generated, it may inherit path attributes, method attributes, body attributes, assertions or combinations thereof from the test template. In some examples, the test elements may inherit the test attributes during runtime execution of the test element. Prior to execution, the link between the test template and the test element may be “soft,” By comparison, when executed, the test element may inherit the test attributes.

Inheriting test attributes from a test template may be beneficial in that it may improve the efficiency of test element generation by alleviating the need to re-write test attributes for each test element. Instead, a test attribute may be written one time in the test template, and simply inherited by test elements that are based on the test template. As will be explained below, inheriting may also be beneficial in that updates to a test attribute may be made once, to the test template, and the updated test attributes may be inherited by the test elements during test element runtime execution. More specifically, inheriting the test attributes during runtime execution may be beneficial in that it allows any update made to a test template to be implemented in the test elements that inherit test attributes during runtime. Inheriting test attributes during runtime execution may facilitate dynamic updating of test elements.

The test elements may then be executed (block 203). Execution (block 203) of a test element may include sending a request to a web service entry point. For example, a test element may request information from a web service entry point. Other examples of test element requests may include testing a functionality of a web service entry point, performing a status check of the web service entry point, retrieving information from a database coupled to the web service entry point, and searching for information within the web service entry point, among other functionalities.

Accordingly, executing (block 203) the number of test elements may also include receiving a response to the request. For example, the execution module (FIG. 1, 112) may receive the information requested. The execution module (FIG. 1, 112) may also receive an indication that an operation was carried out. In yet another example, the execution module (FIG. 1, 112) may receive a status indication from the web service entry point.

Executing (block 203) a test element may include validating the response. Validation may include indicating whether a web service is functioning as expected. Validation may include comparing the response against an assertion, which assertion is an indication of an expected response. Accordingly, a validated response may be a response that is expected by the test element, and which may indicate proper functioning of the web service entry point. By comparison, a response that is not validated may indicate that the web service entry point is not functioning properly or as expected.

In some examples, executing (block 203) a test element may include processing a number of variables included in the number of test elements. The variable may be a response from a previous test element. An example is given as follows. A test element may include a variable that is filled during execution. An example of such a variable may be a login code that is retrieved. During a subsequent test element, the variable may be called and the response filled in as the variable. In other words, the login code may be reused for subsequent test elements.

In some examples, a variable may be set by a variable setting test element, or by an assertion from a test element that may specify that the result of an assertion may be save as a variable. For example, a status result of an assertion may be set as a variable for use in subsequent test elements.

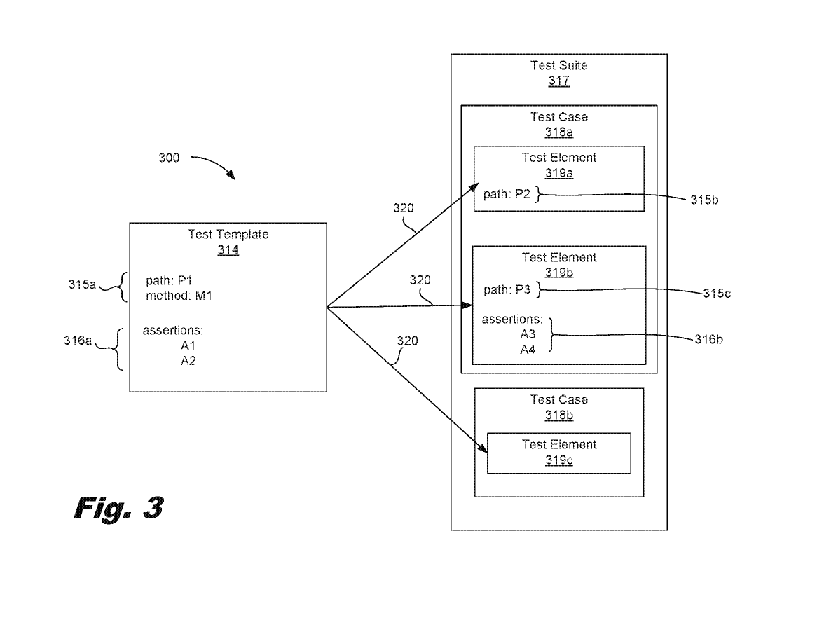

FIG. 3 is a diagram of the hierarchy of a testing system (300), according to one example of the principles described herein. The system (300) may include a test template (314) that describes a web service entry point. For example, the test template (314) may be a test template (314) used to test an authentication entry point of a web service. The test template (314) may include a number of test attributes that describe the web service entry point. In the example depicted in FIG. 3, path and method attributes (315a) of the test template (314) are indicated. For example, the test template (314) may include a path attribute “P1” that indicates the path of the web service entry point. Similarly, the test template (314) may include a method attribute “M1” that indicates a desired action to be performed at the identified entry point. As described above, examples of method attributes include a “GET” attribute and a “POST” attribute. While FIG. 3 indicates path and method attributes (315a) any type of test attribute may be implemented according to the systems and methods described herein. In other words, in addition to the specific examples mentioned above, the test template (314) may include any type of test attribute, which test attribute may refer to any information in a test template (314) that describes the web service entry point.

The test template (314) may also include a number of assertions (316a) that are test attributes that indicate an expected response to a request made to the web service entry point. In the example depicted in FIG. 3, a first assertion “A1” and a second assertion “A2” are contained in the test template (314). Examples of assertions include an expected status code and an expected body message among other expected results.

In addition to describing a web service entry point, the test template (314) may also generate documentation for the web service. For example, as a test template (314) may include a description of a web service, the test template (314) may be processed and used to generate documentation that describes the web service. Similarly, using the information included in a test template (314), test elements (319) may be generated by inheritance using variations that can be applied based on the test template (314). For example, as described above test elements (319) may be generated as described in connection with FIG. 2. However, a test element (319) may also be generated automatically based on the test attributes included in the test template (314). Generation of documentation describing the web service and generation of test elements (319) may be carried out by a module that processes the template information to generate the documentation and test elements (319).The system (300) may also include a number of test elements (319). As described above, the test elements (319) may execute actions and validate responses to the actions. The test elements (319) may carry out functional testing, i.e., testing to determine whether an operation enabled by the test element (319) functions as expected. The test elements (319) may also carry out regression testing, i.e., testing to determine whether a change to a web service affects other features of the web service. As described above, the test elements (319) may inherit test attributes from the test template (314) as indicated by the arrows (320). While FIG. 3 depicts the test elements (319) as inheriting the test attributes (i.e., path and method attributes (315a) and assertions (316a)from the test template (314), the test elements (319) may also inherit test attributes from other test elements (319), for example, test elements (319) that have already been performed. In the system (300), test templates (314) and test elements (319) may have a similar structure. However, test elements (319) may be executed while test templates (314) may be inherited.

In addition to inheriting a number of test attributes, a test element (319) may also overwrite a number of test attributes to implement a variation of a test template (314). An example is given as follows. As described above, a test template (314) may be generated to test an authentication web service entry point. Accordingly, a number of test elements (319) may be generated to test various aspects of the web service entry point authentication. For example, a first test element (319a) may test an authentication of a valid user. A second test element (319b) may test the web services action with regards to an unauthorized user. A third test element (319c) may test the web services response to a default user. In this example, each of the test elements (319) may inherit test attributes from the test template (314) and overwrite other test attributes to reflect the specific functionality to be tested by each test element (319). In one example, the test element (319) may inherit all the test attributes from the test template (314). Specific examples of inheriting test attributes are given as follows. The first test element (319a) may include a path attribute (315b) “P2” that has overwritten the path attribute (315a) “P1” from the test template (314). Similarly, the second test element (319b) may include a path attribute (315c) “P3” that has overwritten the path attribute (315a) “P1” from the test template (314). The second test element (319b) may include assertions (316b) “A3” and “A4” that have overwritten the assertions (316a) “A1” and “A2” from the test template (314). In FIG. 3, any test attribute that is not overwritten, and is inherited, is not visualized in the test element (319). For example, a third test element (319c) may inherit the path and method attributes (315a) and assertions (316a) as they are in the test template (314) and may avoid overwriting them.

In some examples, a number of test elements (319) may be grouped into a number of test cases (318). Test cases (318) may be containers for test elements (319) such that a test case (318) may group a number of test elements (319) that test a similar functionality of the web service. For example, a first test case (318a) may contain the first test element (319a) and the second test element (319b). Similarly, a second test case (318b) may contain the third test element (319c). Likewise a number of test cases (318) may be grouped into a larger unit such as a test suite (317).

Again, while FIG. 3 depicts particular types of attributes such as path and method attributes (315a) and assertions (316a), a test template (314) may include any type of information that describes a web service entry point, and the test elements (319) may inherit the information that describes a web service entry point.

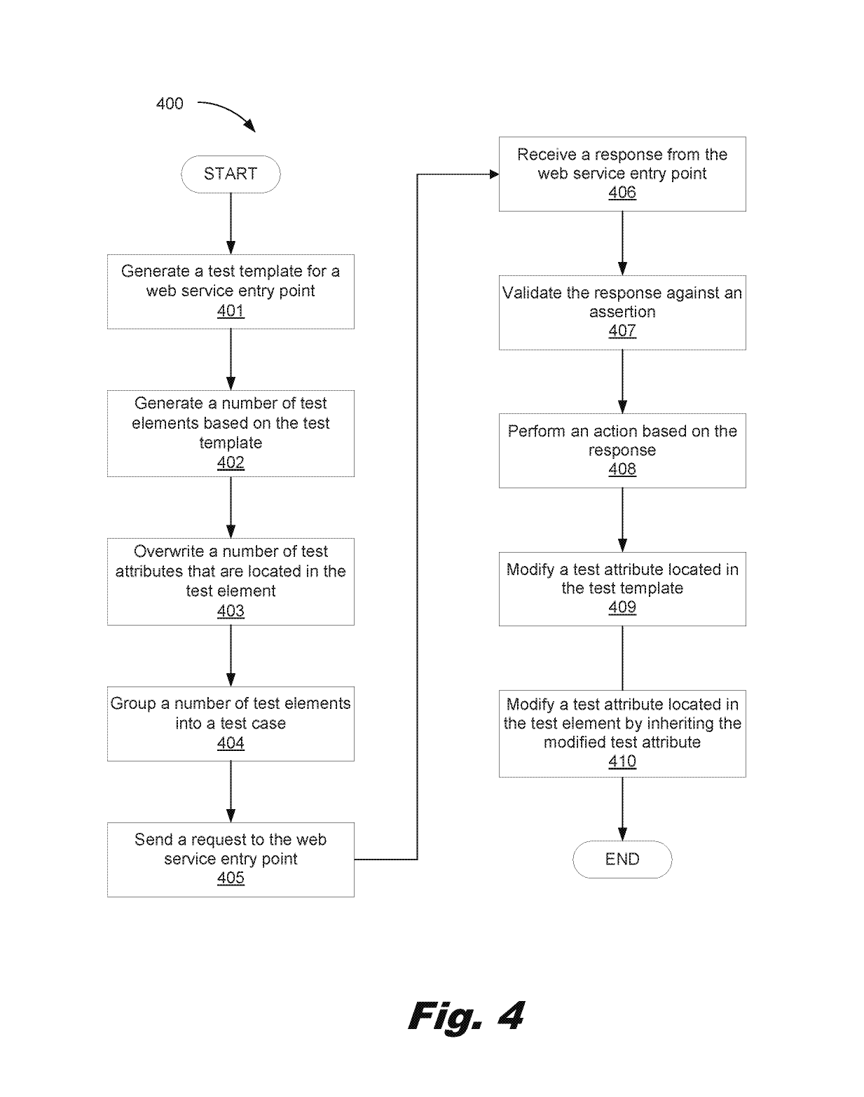

FIG. 4 is a flowchart of another method (400) for testing a web service using inherited test attributes, according to another example of the principles described herein. The method (400) may include generating (block 401) a test template (FIG. 3, 314) for a web service entry point. This may be performed as described in connection with FIG. 2.

A number of test elements (FIG. 3, 319) may be generated (block 402) based on the test template (FIG. 3, 314). This may be performed as described in connection with FIG. 2.

A number of test attributes, including assertions (FIG. 3, 316b), located in a test element (FIG. 3, 319) may be overwritten (block 403). For example, a test element (FIG. 3, 319) may include a test attribute that is a variation of a test attribute that has been included in a test template (FIG. 3, 314) as indicated by the example in FIG. 3. In a specific example, a test element (FIG. 3, 319) may include a different path attribute than a test template (FIG. 3, 314). While the test attribute in a test element (FIG. 3, 319) may be overwritten, the test attribute in the test template (FIG. 3, 314) may remain as written. Overwriting (block 403) a number of test attributes, including assertions, in a test element (FIG. 3. 319) may be beneficial by allowing customization of test elements (FIG. 3, 319) based on foundation test attributes in a test template (FIG. 3, 314). This may reduce redundancy in re-writing testing attributes while allowing test elements (FIG. 3, 319) to be written specifically to test a particular functionality of the web service entry point.

A number of test elements (FIG. 3, 319) may be grouped (block 404) into a test case (FIG. 3, 318). A test case (FIG. 3, 318) may be a group of test elements (FIG. 3, 319) that are generated to test a related functionality of a web service entry point. For example, in a test case (FIG. 3, 318) relating to authentication, a first test element (FIG. 3, 319a) may test authorization of a valid user and a second test element (FIG. 3, 319b) may test management of an unauthorized user.

As part of executing the test element (FIG. 3, 319), the execution module (FIG. 1, 112) may send (block 405) a request to the web service entry point. The request may test a functionality of a web service entry point. As described above, examples of test element (FIG. 3, 319) requests may include testing a functionality of a web service entry point, performing a status check of the web service entry point, retrieving information from a database coupled to the web service entry point, and searching for information within the web service entry point, among other functionalities. Accordingly, the execution module (FIG. 1, 112) may send (block 405) a request to the web service entry point to test a functionality of the web service entry point.

In response, the execution module (FIG. 1, 112) may receive (block 406) a response from the web service entry point. The response may indicate an operation performed (or not performed) by the web service entry point in response to the request. For example, the execution module (FIG. 1, 112) may receive the information requested. The execution module (FIG. 1, 112) may also receive an indication that an operation was carried out or that an operation was not carried out. In yet another example, the execution module (FIG. 1, 112) may receive a status indication from the web service entry point.

The execution module (FIG. 1, 112) may validate (block 407) the response against an assertion (FIG. 3, 316). As described above, an assertion (FIG. 3, 316) may be a response that is expected or that indicates expected operating conditions. For example, an assertion (FIG. 3, 316) may be an expected status for a particular web service entry point. Accordingly, the execution module (FIG. 1, 112) may receive a status as a response, and compare the received status with an expected status. In this example, a response that matches an expected response may be validated, or may “pass” the test. By comparison, a response that does not match an expected response may not be validated, or may “fail” the test.

In some examples, based on the response, an action may be performed (block 408). For example, if a test is “failed” an alert, or report, may be triggered to notify an individual. Similarly, if a test is “failed” a remediation process may be implemented to correct any deficiencies.

In some examples, a test attribute located in a test template (FIG. 3, 314) may be modified (block 409). For example, a path attribute may be modified to reflect a change in the path to access a web service. Accordingly, the path attribute located in the test template (FIG. 3, 314) may be updated to reflect the change. The test attribute located in the test element (FIG. 3, 319) may similarly be updated. For example, the test elements (FIG. 3, 319) may inherit the updated test attributes based on the updated test attribute in the test template (FIG. 3, 314). As described above, the test attributes may be inherited during runtime execution of the test element (FIG. 3, 319) and any link between the test attribute in the test template (FIG. 3, 314) and the test element (FIG. 3, 319) prior to runtime execution may be “soft.” Accordingly, any changes made to the test attributes in the test template (FIG. 3, 314) may be inherited by the test element (FIG. 3, 319) during runtime execution of the test element (FIG. 3, 319).

Modifying a test attribute in the test template (FIG. 3, 314) and inheriting the modified test attribute in the test elements (FIG. 3, 319) may be beneficial in that any modification to a test attribute may be made once in the test template (FIG. 3, 314) and instances of the test attribute in the test elements (FIG. 3, 319) merely inherit the modification without re-writing each test attribute located in the test elements (FIG. 3, 319).

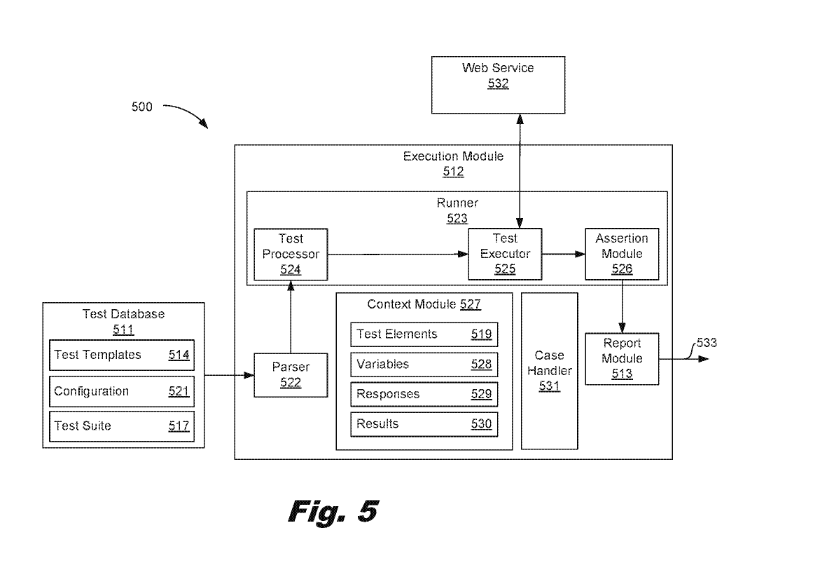

FIG. 5 is a diagram of a system (500) for testing a web service (532) using inherited test attributes (FIG. 3, 315), according to one example of the principles described herein. The system may include a test database (511). As described above the test database (511) may include test templates (514) that describe a web service entry point. The test database (511) may also store configuration (521) information. The configuration (521) information may indicate a base path for a web service. For example, the configuration (521) information may indicate a base uniform resource locator (URL) for a web service. The test database (511) may also store test suites (517) that have been run previously.

Within the execution module, a context module (527) may store test-related information. From the context module (527) the test-related information may be referenced during a run-time execution of a test element (FIG. 3, 319). More specifically, the context module (527) may store test elements (519) that have previously been executed. For example, as described above a first test element (519) may request a variable to be returned. Accordingly, the context module (527) may store this test element (519) and the variable (528) that was returned, or any other variable (528). The context module (527) may also store any response (529) to a request made to the web service (529). The context module (527) may also include results (530) of a validation of a response. For example, the context module (527) may indicate whether a test element (FIG. 3, 319) was “passed” or “failed.”

In some examples, a test element (FIG. 3, 319) may include specific operations to be executed. For example, a test element (FIG. 3, 319) may request a web service (532) to perform a maintenance task. In this example, the operations may be stored in a case handler (531). During execution, the operation may be called by a test element (FIG. 3, 319) while remaining isolated from the test suite (517).

A parser (522) may retrieve information from the test database (511) to generate a test element (FIG. 3, 319). More specifically, as described above, the parser (522) may allow a test element (FIG. 3, 319) to inherit test attributes from the test template (514). In addition to inheriting a number of test attributes, the parser (522) may carry out other operations to allow the test element (FIG. 3, 319) to become an executable entity.

A runner (523) may execute the number of test elements (FIG. 3, 319). More specifically, a test processor (524) may process a test element (FIG. 3, 319). For example, if a test element (FIG. 3, 319) includes any variables (528), the test processor (524) may process the variables, provide the information to a current test element (FIG. 3, 319) and a test executor (525) may execute the current test element (FIG. 3, 319). In some examples, executing a test element (FIG. 3, 319) may include sending a request to a web service (532) entry point. This may be performed as described above. After receiving a response, an assertion module (526) may validate the response. In other words, the assertion module (526) may compare the response to an expected result. The runner (523) may continue this process until test elements (FIG. 3, 319) in a test case (FIG. 3, 318) have been executed. A test case (FIG. 3, 318) may “pass” if all assertions (FIG. 3, 316) in the included test elements (FIG. 3, 319) have “passed.”

A report module (513) may generate a report (533). The report (533) may indicate whether the test elements (FIG. 3, 319), or a test case (FIG. 318), passes. More specifically, the report (533) may indicate which test elements (FIG. 3, 319) of a test case (FIG. 3, 318) did not pass, or that were not validated. The report (533) may be based on user input. For example, a user may indicate what information is to be included in the report (533).

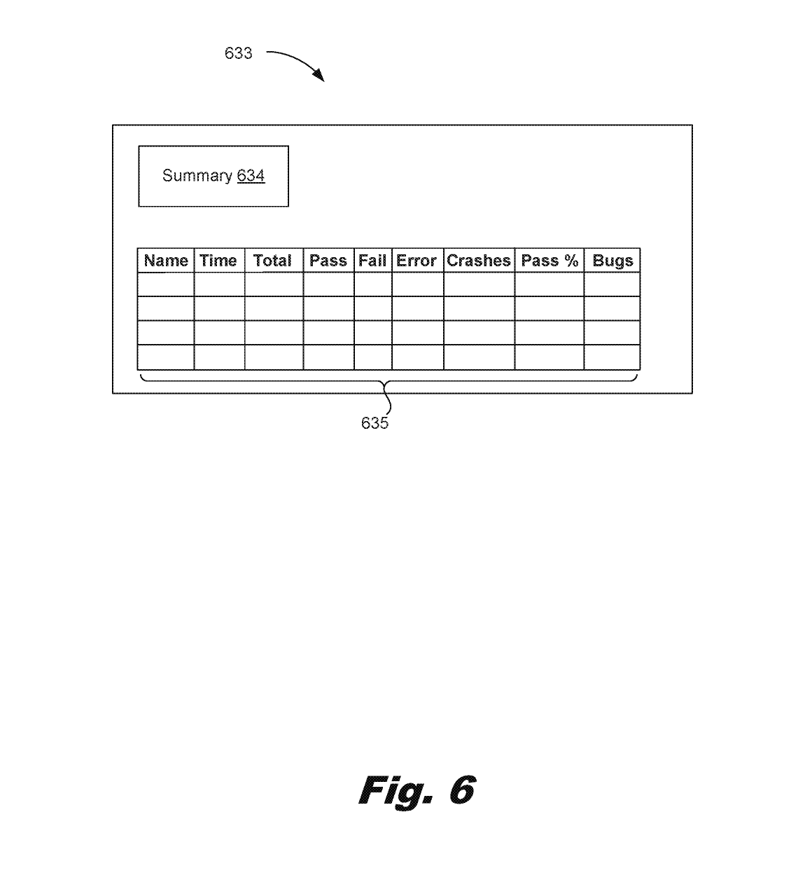

FIG. 6 is a test report (633), according to one example of the principles described herein. The test report (633) may communicate information relating to an executed test element (FIG. 3, 319) or test case (FIG. 3, 318). The test report (633) may include a summary field (634) that summarizes the execution of the test. For example, the summary field (634) may indicate a pass rate for a test case (FIG. 3, 318), a number of tests run, a number of tests failed, and a number of errors received.

The test report (633) may also include a detailed analysis field (635) that indicates more specific information relating to the execution of the test case (FIG. 3, 318). For example, the detailed analysis field (635) may indicate a name of a test element (FIG. 3, 319). Other information that may be included in the detailed analysis field (635) may include a time when a test element (FIG. 3, 319) was executed, a number of times a test element (FIG. 3, 319) has been run, a number of times a test element (FIG. 3, 319) has passed, a number of times a test element (FIG. 3, 319) has failed, a number of errors detected during an execution of a test element (FIG. 3, 319), a number of crashes during a test element (FIG. 3, 319), a pass rate for the test element (FIG. 3, 319) and a bug identified in a test element (FIG. 3, 319). While specific reference is made to information contained in the test report (633), the test report (633) may be generated according to input. Accordingly, a user may indicate the information that is to be included in the test report (633).

Methods and systems for testing web services using inherited test attributes may have a number of advantages, including: (1) simplifying long-term maintenance of large test suites; (2) reducing the cost associated with writing large test suites; (3) reducing the redundancy in test cases; (4) increasing response to changes in a web service; and (5) increasing efficiency in keeping large test suites up to date.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for testing a web service using inherited test attributes, comprising:
generating a test template for a web service entry point, in which a test template comprises a number of test attributes;
generating a number of test elements based on the test template, in which a test element inherits the number of test attributes; and
executing the number of test elements.

2. The method of claim 1, further comprising overwriting, in the test elements, a number of test attributes that are located in the test element.

3. The method of claim 1, further comprising generating documentation to describe the web service entry point based on the test template.

4. The method of claim 1, further comprising grouping a number of test elements into a test case, in which a test case is a container for a number of test elements.

5. The method of claim 1, further comprising:
modifying the test attributes located in the test template to reflect changes in a web service entry point; and
modifying the test attributes located in the test element by inheriting the modified test attributes located in the test template.

6. The method of claim 1, in which executing the number of test elements comprises:
sending a request to the web service entry point; and
receiving a response from the web service entry point.

7. The method of claim 6, further comprising validating the response against an assertion.

8. The method of claim 7, further comprising performing an action based on the response.

9. The method of claim 1, in which the test element inherits the number of test attributes from a test template, another test element, or combinations thereof.

10. A system for testing a web service using inherited test attributes, comprising:
a processor;
a memory communicatively coupled to the processor, the memory comprising:
a test database to store a number of test templates for a number of web service entry points, in which a test template comprises a number of test attributes to describe a web service entry point;
a parser to generate a number of test elements to test the web service, in which the number of test elements inherit the number of test attributes from the number of test templates; and
a runner to execute the number of test elements.

11. The system of claim 10, in which executing the number of test elements comprises processing a number of variables included in the number of test elements.

12. The system of claim 11, in which the number of variables are responses from a previous test element.

13. The system of claim 10, further comprising a report module to generate a report.

14. The system of claim 10, further comprising a case handler to execute specific testing operations.

15. A computer program product for testing a web service using inherited test attributes, the computer program product comprising:
a computer readable storage medium comprising computer usable program code embodied therewith, the computer usable program code comprising computer usable program code to, when executed by a processor:
generate a test template for a web service entry point, in which a test template comprises a number of test attributes;
generate a number of test elements based on the test template, in which a test element inherits the number of test attributes;
group a number of test elements into a number of test cases;
execute the number of test cases; and
generate a test report based on the execution of the test cases.
